(19) United States
(12) Patent Application Publication
(10) Pub. No.: US 2009/0127744 A1
(43) Pub. Date: May 21, 2009

(54) DEVICE AND METHOD FOR HANDLING A QUANTITY OF PLASTIC IN THE MOLTEN STATE

(76) Inventor: Dominique Hanot, Vouvry (CH)

Correspondence Address: NIXON & VANDERHYE, PC, 901 NORTH GLEBE ROAD, 11TH FLOOR, ARLINGTON, VA, 22203, US

(21) Appl. No.: 12/299,086

(22) PCT Filed: Apr. 24, 2007
(86) PCT No.: PCT/IB2007/051513

§ 371 Date: Jan. 16, 2009

(30) Foreign Application Priority Data
May 1, 2006 (EP) 06113344.3

(51) Int. Cl. B29C 39/02

(52) U.S. Cl. 264/299; 425/256

(57) ABSTRACT

The invention relates to a device for moulding a plastic article in which the article is obtained by the compression of a metered quantity of plastic (3) in the molten state between the two parts of a mould, comprising at least one supply of plastic (1), a rod (11), sliding in a sleeve (8) suitable for temporarily supporting said metered quantity of plastic (3), a mould for the head of the article (6, 7) and a mandrel (18) cooperating with said mould (6, 7), the sleeve (8) having an upper face (16) and a lateral wall (17), the device being characterized in that it includes means for depositing the metered quantity on the sleeve (1, 2), which means are designed so that the amount of plastic (22) lying above a plane (20) coinciding with the upper face (16) of the sleeve (8) is between 20% and 40% of the total mass of the metered quantity (3). The invention also relates to a method using the aforementioned device.

### FIELD OF THE INVENTION

The present invention relates to the compression moulding of plastic articles, in which an article is obtained by the compression of a quantity of plastic in the molten state between the two parts of a mould.

The present invention is applied more particularly to the production of plastic tubes, for example for toothpaste or cosmetics, the tube being formed from a flexible cylindrical body attached to a head comprising a shoulder and an orifice. In this particular case, the head of the tube is formed and simultaneously welded to the body in one operation. The head of the tube is produced from a metered quantity of molten material which is moulded and compressed between a lower tool known as the die assembly and an upper tool known as the mandrel, onto which the flexible cylindrical body is fitted. The temperature of the material is such that it is welded to the body of the tube. In a machine for producing tubes, a plurality of moulds are generally moved by a discontinuous (or continuous) movement, each mould being subjected to the various steps of the method (loading of the tube body, depositing the metered quantity of plastic, compression moulding, cooling, demoulding and discharge of the tube).

### PRIOR ART

Devices and methods for producing such tubes are known in the prior art. By way of example, mention may be made of application DE 103 49 837 and U.S. Pat. No. 4,943,405, the contents of which is incorporated by way of reference in the present application as regards the description of said methods and devices.

Application DE 103 49 837 describes a device and a method for producing tubes in which a metered quantity of annular shape is deposited on a sleeve acting as intermediate support and through which a rod is mounted so as to slide. The rod is held in the high position by means of a spring and is pushed back against the force of the spring when the mandrel is being introduced into the die to form the head.

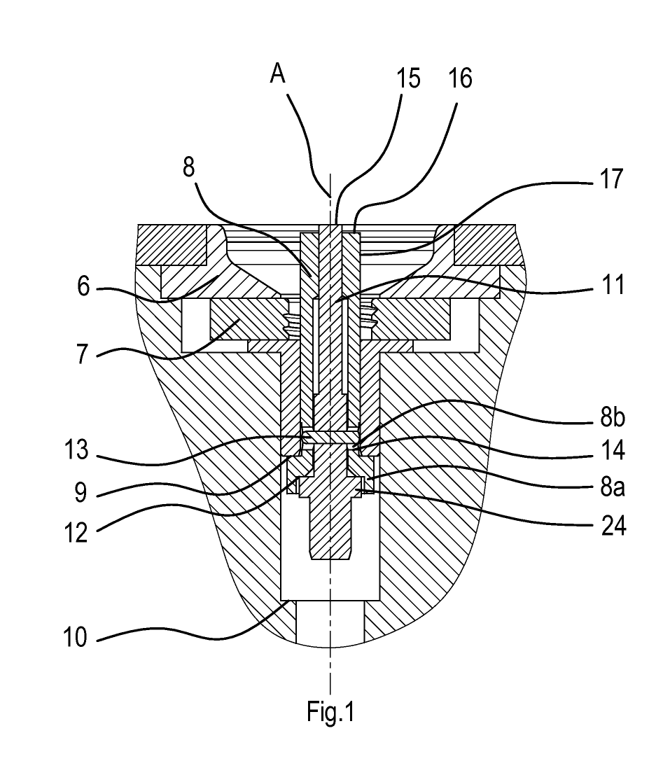

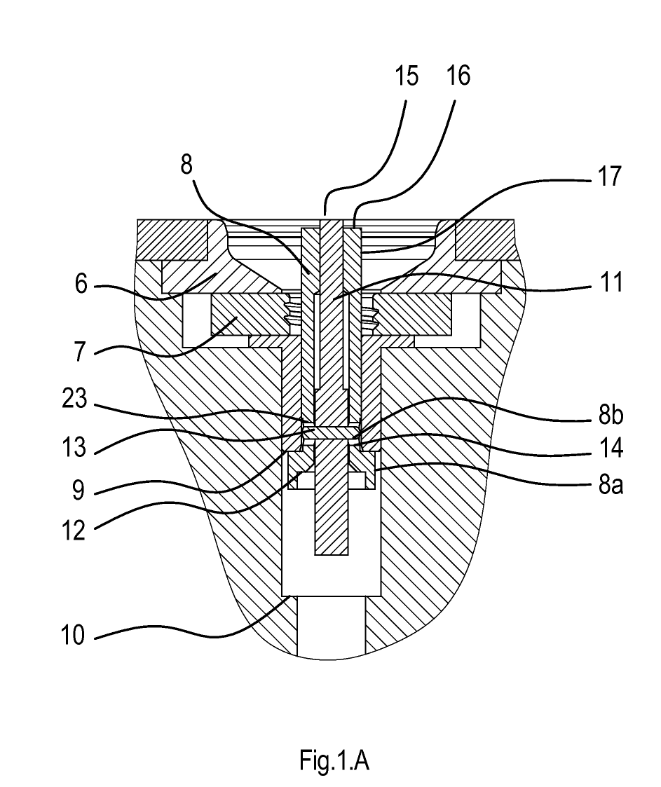

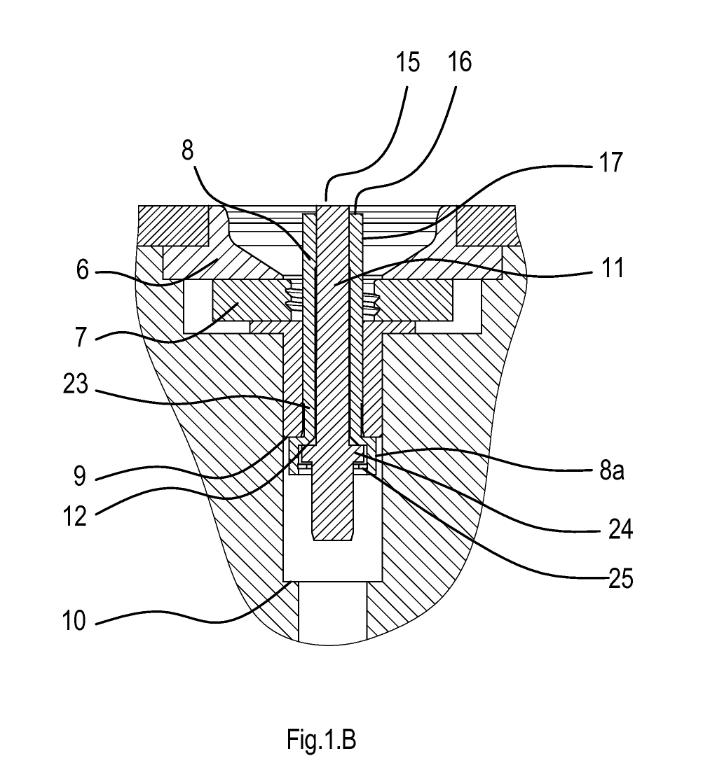

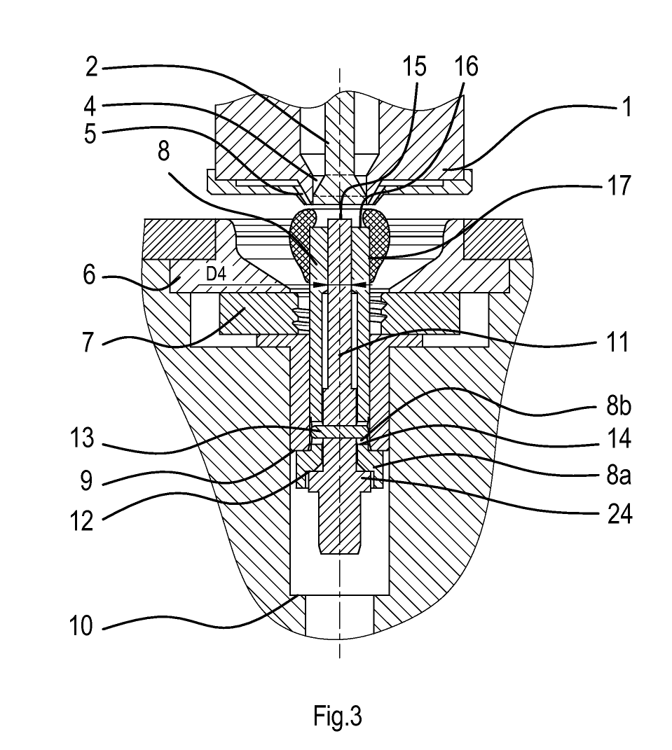

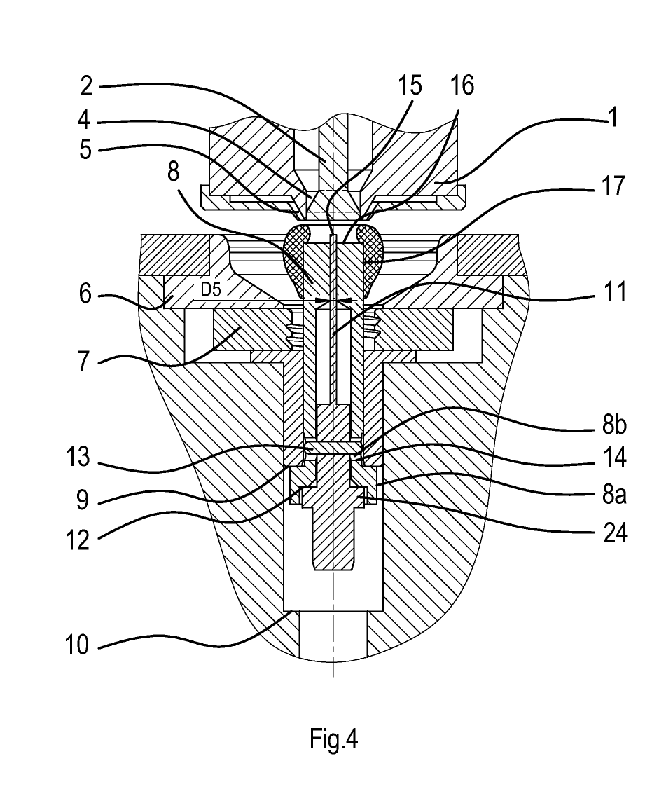

In U.S. Pat. No. 4,943,405, and as shown in FIG. 1 thereof, a metered quantity of plastic in annular form is deposited from a supply of material onto the upper face of a sleeve and around the rod which is used to form the orifice in the shoulder. The outlet of the supply of material is surrounded by an annular nozzle which allows the projection of pressurized air to separate the metered quantity of deposited material from the supply of material, once the desired metered quantity of material has been deposited. Once the metered quantity of material has been deposited on the sleeve, the supply of material is removed and a mandrel is introduced which has the shape of the shoulder to be created. The front face of the mandrel comes into contact with the upper face of the rod and the sleeve-rod assembly is pushed back inside the shoulder die and thread-forming die to form the head which is to become the end of the tube. FIGS. 3 and 4 of this patent illustrate this step of forming the head and the welding thereof on the body of the tube carried by the mandrel. The orifice of the head is formed by the rod which is longitudinally displaced in the sleeve. During this step of forming the head and the displacement of the mandrel in the die, the rod is pushed back axially into the sleeve by the mandrel from an upper position to a lower position in which it is used to form an orifice in the shoulder by protruding beyond the upper face of the sleeve.

One problem encountered in U.S. Pat. No. 4,943,405 and in application DE 103 49 837 is due to the temporary positioning of the metered quantity of plastic on the sleeve. Depending on the distribution of the plastic between the upper surface and the lateral wall of the sleeve, the quality of the moulded article may be considerably improved or degraded.

Thus one of the objects of the invention is to improve the known methods and devices.

More particularly, one of the objects of the invention is to propose a system allowing suitable distribution of the plastic on the sleeve.

A further object of the invention is to propose a method for forming shoulders of tubes which is more efficient than the known methods.

### GENERAL DESCRIPTION OF THE INVENTION

The invention, therefore, relates to a device for moulding a plastic article in which the article is obtained by the compression of a metered quantity of plastic in the molten state between the two parts of a mould, comprising at least one supply of plastic, a rod, sliding in a sleeve suitable for temporarily supporting said metered quantity of plastic, a mould for the head of the article and a mandrel cooperating with said mould, the sleeve having an upper face and a lateral wall. The device according to the invention is characterized in that it includes means for depositing the metered quantity on the sleeve, which means are designed so that the amount of plastic lying above a plane coinciding with the upper face of the sleeve is between 20% and 40% of the total mass of the metered quantity.

Preferably, the ratio of the mass of plastic lying above the plane to the mass of plastic lying below the plane is approximately 30/70.

### DETAILED DESCRIPTION OF THE INVENTION

The invention will be better understood by the following description of an embodiment thereof and the accompanying figures, in which:

FIG. 1 shows the lower part of the mould, the die assembly;

FIG. 1a shows a variant of the embodiment of FIG. 1;

FIG. 1b shows a variant of the embodiment of FIG. 1;

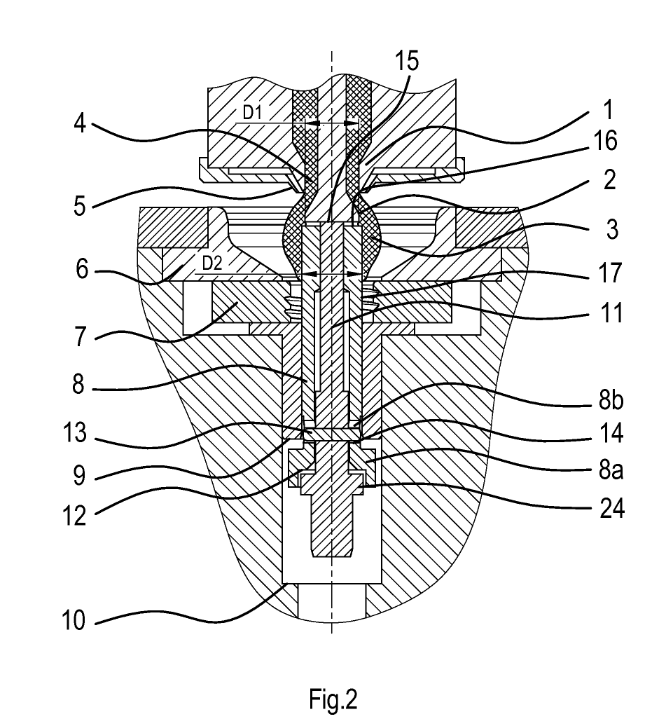

FIG. 2 shows an open metering nozzle forming a metered quantity of plastic in the lower part of the mould;

FIG. 3 shows a closed metering nozzle and the metered quantity of material in position in the lower part of the mould;

FIG. 4 corresponds to FIG. 3 but with an orifice rod of small diameter;

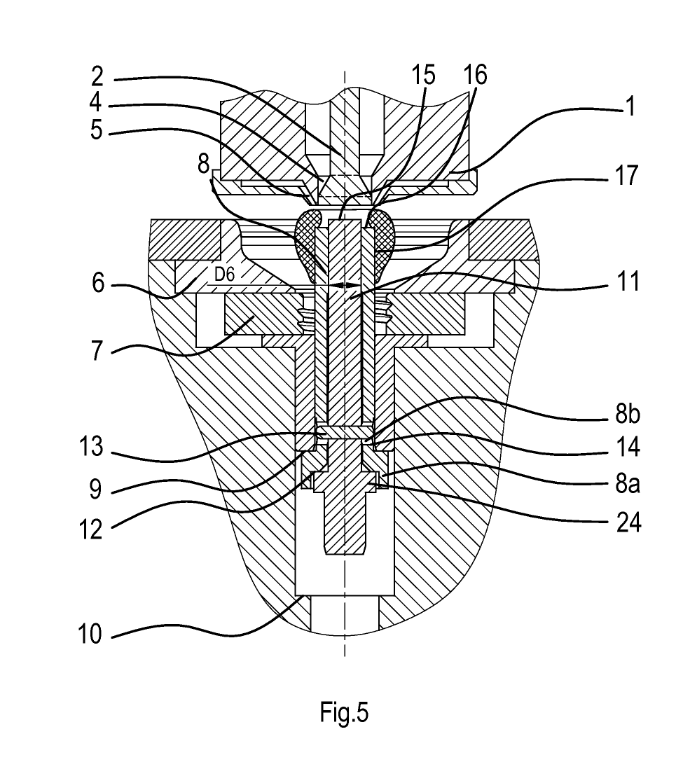

FIG. 5 corresponds to FIG. 3 but with an orifice rod of large diameter;

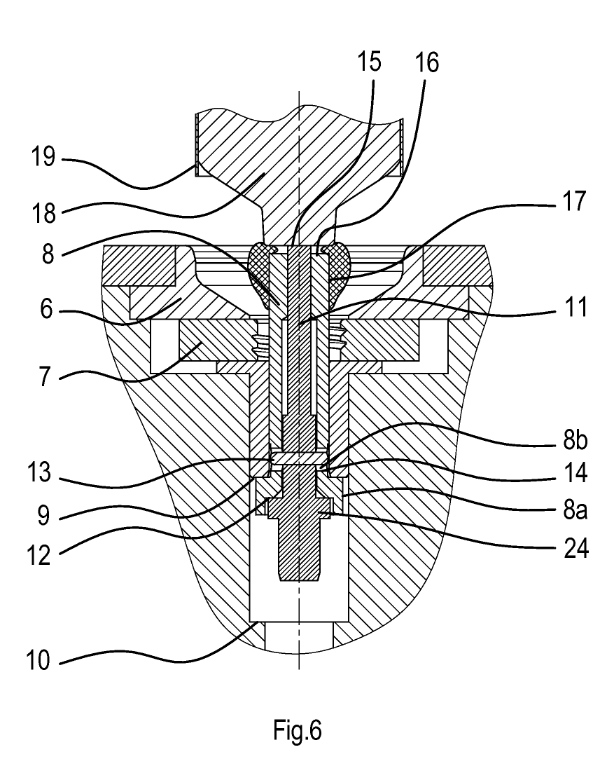

FIG. 6 shows the mandrel and the die assembly at the start of the compression phase;

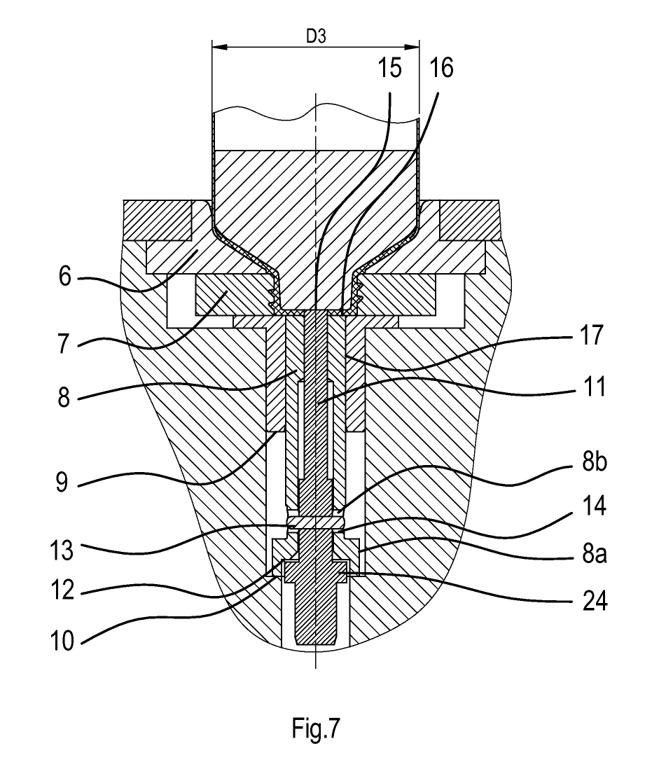

FIG. 7 shows the end of the compression phase; and

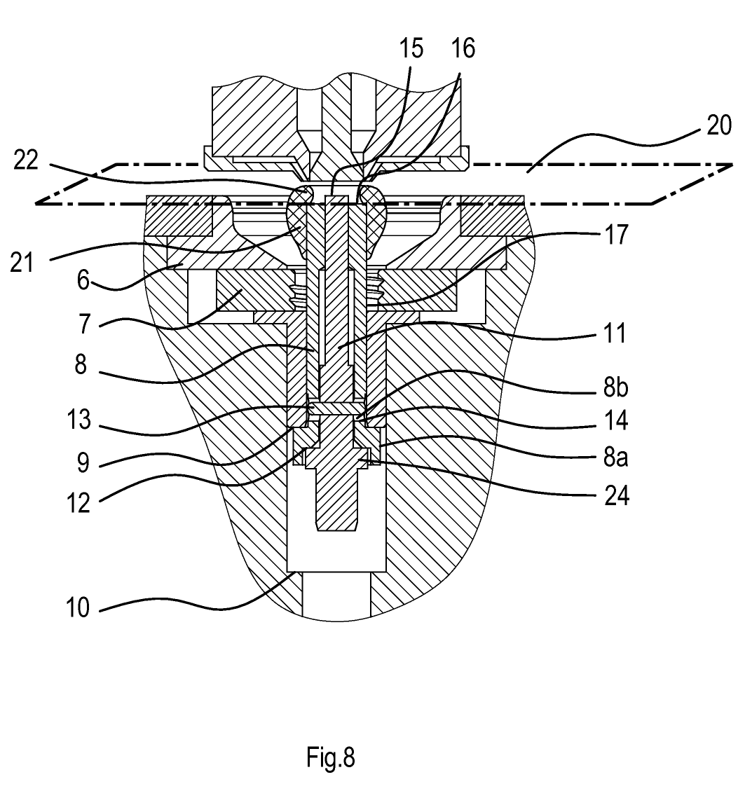

FIG. 8 illustrates the manner in which the metered quantity of material is deposited on the sleeve.

FIG. 1 shows the lower part of the mould, known as the die assembly, in the resting position, comprising a shoulder die 6 which is to form the external part of the head of the tube, a thread-forming die 7 in a plurality of parts to allow the demoulding of the threaded portion and, within the axis of symmetry of the device, a sleeve 8 able to be displaced in translation according to the axis A. The sleeve 8 comprises a first shoulder 8a which limits its path between two stops 9 and 10.

The die assembly also comprises an orifice rod 11 which is used to form the orifice of the shoulder. The orifice rod 11 comprises a shoulder 24 in its lower part and may slide in the sleeve 8. The path of the orifice rod 11 is limited in the upper position by means of the shoulder 24 and by a stop 12 arranged on the sleeve. The path of the orifice rod 11 is also limited in the lower position by a pin 13, for example of cylindrical shape, and by a stop 14 arranged on the sleeve 8, the stop 14 being formed by the lower wall of an elongate hole 8b in said sleeve 8. The pin 13 is preferably placed, for example driven-in, perpendicularly into a hole in the rod 11. This pin allows the relative displacement in the axial direction of the rod 11 and the sleeve 8 to be blocked in a straight-forward manner. This blocking is particularly important once the metered quantity of material has been deposited and the mandrel is in contact with the upper face of the rod, to form the shoulder. In the known systems using springs, in such a position, the rod was still able to be displaced, in particular under the effect of the material which is moulded by compression in this method and thus could give rise to faults, such as for example a blocked or deformed orifice or an orifice of diameter equivalent to the external diameter of the sleeve 8.

FIG. 1A shows a variant of the device of FIG. 1 in which the shoulder 24 of the orifice rod 11 is dispensed with and the upper stop 23 is produced by the contact of the cylindrical pin 13 on the upper wall of the elongate hole 8b. This variant has the advantage of a great simplicity of manufacture and implementation. By using a single pin for the two stops 14, 23, the construction of the device is simplified.

The relative displacements of the sleeve 8 and the orifice rod 11 are performed by an actuator (not shown) such as a spring or pneumatic cylinder acting on the orifice rod 11.

In FIGS. 2 and 3, the steps for depositing a metered quantity of molten plastic are shown. A metering nozzle 1 positioned above the die 6 and concentric to the sleeve 8 forms a metered quantity 3 of molten plastic. The metering nozzle 1 is supplied by an extruder (not illustrated) known in the prior art.

In FIG. 2, the valve 2 executes a linear path generated by an actuator (not illustrated) which allows the formation of an annular metered quantity of material 3 through the passage 4 and the depositing thereof on the upper face 16 and the periphery 17 of the sleeve 8.

In FIG. 3, the actuator subsequently drives the valve 2 in the reverse direction which causes the closure of the outlet orifice 4. The metered quantity of plastic is cut and released by blowing a gas through the passage 5.

So that the metered quantity of plastic 3 is correctly deposited on the sleeve 8 as FIG. 3 illustrates, i.e. so that it is in contact with its upper face 16 and its periphery 17, it is necessary to combine several conditions:
the distance between the upper face 15 of the orifice rod 11 and the upper face 16 of the sleeve 8 has to be slightly greater than the thickness of the corresponding wall of the moulded part (head of the tube);
the valve 2 has to be very close or preferably has to come into contact with the surface 15 of the orifice rod 11 during the phase of opening the metering nozzle; and.
the diameter of the valve 2 is chosen according to the diameter of the sleeve 8. For example, for a sleeve with a diameter D2=14.5 mm, the diameter of the valve is D1=13 mm. The swelling of the material on leaving the metering nozzle allows the lower part of the metered quantity to pass onto the periphery of the sleeve over a distance of 13 mm and the valve has performed a travel of 7 mm (FIG. 2). Upon closing the metering nozzle, the valve performs the reverse travel, the position of the material not changing relative to the sleeve 8. The metered quantity of material is separated from the nozzle by a short jet of air so that the upper part of the metered quantity shrinks onto the upper face of the sleeve 8 (FIG. 3). Finally, about 75% of the height of the metered quantity lies on the periphery of the sleeve and about 25% lies above the upper face of the latter, resulting in a mass distribution of the metered quantity of 20 to 40% lying above a plane 20 coinciding with the upper face of the sleeve and 80 to 60% lying beneath it, respectively.

In the case of this invention, the metered quantity of material is deposited on the sleeve 8 (on the upper face 16 and on the periphery 17). It is, therefore, perfectly centred and is not liable to be displaced during the movements of the tools. Moulding errors are eliminated. In addition, if, for the same diameter of tube, the diameter of the orifice varies, it is possible to maintain the same diameter of metering valve because the diameter of the sleeve 8 remains identical (see FIG. 4 small orifice (D5), FIG. 5 large orifice (D6)). In factories for producing cosmetic tubes, it is usual that a production line produces a tube which is always of the same diameter but with frequent changes to the diameter of the orifice. The invention, therefore, makes it possible to gain time in the changing of tools as this avoids changing the diameter of the metering nozzle as well as further adjustments thereto. In addition, this allows the required range of diameters of metering nozzles to be reduced for the production of a range of tube diameters (for example if 6 different nozzles were necessary, the new method would only require 3 different diameters).

In the following step shown in FIG. 6, the lower part of the mould, known as the die assembly and comprising the die 6 has left the metering nozzle 1 and a mandrel 18 is positioned above and centred relative thereto. The cylindrical body of the tube 19 is fitted in position on the mandrel 18. The mandrel 18 is displaced towards the die 6 and comes into contact with the orifice rod 11 on its upper face 15. It thus drives the assembly of the orifice rod 11 and the sleeve 8 until said sleeve bears against the stop 10 (see FIG. 7). During this displacement, the cylindrical pin 13 may come into contact with the lower stop 14 which guarantees that the lower face of the mandrel 18 never comes into contact with the face 16 of the sleeve 8. At the end of the displacement, the shoulder 8a of the sleeve 8 comes into contact with the stop 10. The upper face 15 of the orifice rod 11 always remains in contact with the mandrel 18 and the pin 13 is not in contact with the stop 14. This configuration has the advantage of easily forming the orifice of the tube around the orifice rod 11. The metered quantity of plastic 3 is progressively deformed until it fills the cavity formed by the die assembly and the mandrel 18 and is welded to the end of the body of the tube 19. The assembly remains under pressure during the cooling phase.

FIG. 8 shows the same device and the same configuration as the device and the configuration illustrated in FIG. 3, and it differs solely therefrom in the manner in which the metered quantity of material 3 deposited on the sleeve 8 is illustrated.

The plastic forming the metered quantity of material 3 is located both on the upper face 16 and the lateral wall 17 of the sleeve 8.

The metered quantity of plastic deposited along or in the extension of the lateral wall 17 of the sleeve 8 is much greater than the metered quantity of plastic deposited above the upper face 16 of the sleeve 8.

However, the presence of plastic above the upper face 16 of the sleeve 8 has several advantages, in particular the fact of efficiently retaining the metered quantity of material 3 in a specific position. The risk of premature falling of the metered quantity of material 3 along the sleeve 8 is thus eliminated. It will be revealed here that this risk is present in the device disclosed in German patent application DE 103 49 837, as in this case, the entire metered quantity of material is located on the lateral wall of the sleeve.

Surprisingly, it has been observed that the quality of moulded articles was improved if the plastic was distributed in a specific manner between the areas which are respectively located above and below a plane 20 coinciding with the upper face of the sleeve 8. More specifically, the quality of the moulded articles is improved if the metered quantity of plastic 22 lying above the plane 20 represents between 20 and 40% of the total mass of the metered quantity of material 3 and if the metered quantity of plastic 21 lying below the plane 20 respectively represents between 80 and 60% of the total mass of the metered quantity of material 3. Preferably, the upper mass/lower mass ratio is approximately 30/70.

It goes without saying that the invention is not limited to the examples shown above.

1. Device for moulding a plastic article in which the article is obtained by the compression of a metered quantity of plastic (3) in the molten state between the two parts of a mould, comprising at least one supply of plastic (1), a rod (11), sliding in a sleeve (8) suitable for temporarily supporting said metered quantity of plastic (3), a mould for the head of the article (6, 7) and a mandrel (18) cooperating with said mould (6, 7), the sleeve (8) having an upper face (16) and a lateral wall (17), the device being characterized in that it includes means for depositing the metered quantity on the sleeve (1, 2), which means are designed so that the amount of plastic (22) lying above a plane (20) coinciding with the upper face (16) of the sleeve (8) is between 20% and 40% of the total mass of the metered quantity (3).

2. Device according to claim 1, characterized in that the ratio of the mass of material (22) above the plane (20) to the mass of material (21) below the plane (20) is approximately 30/70.

3. Assembly consisting of a device as defined in claim 1, and a metered quantity of plastic (3) placed temporarily on the free end of the sleeve (8), characterized in that the metered quantity of plastic (22) lying above a plane (20) coinciding with the upper face of the sleeve (8) is between 20% and 40% of the total mass of the metered quantity of material (3).

4. Assembly according to claim 1, characterized in that the ratio of the mass of material (22) above the plane (20) to the mass of material (21) below the plane (20) is approximately 30/70.

5. Method for moulding a metered quantity of plastic (3) by means of a device as defined in claim 1, characterized in that the metered quantity of material (3) is deposited on the upper face (16) and on the lateral wall (17) of the sleeve (8) so that the metered quantity of plastic (22) lying above a plane (20) coinciding with the upper face of the sleeve (8) is between 20% and 40% of the total mass of the metered quantity of material (3).

6. Method according to claim 1, characterized in that the ratio of the mass of material (22) above the plane (20) to the mass of material (21) below the plane (20) is approximately 30/70.
